(19) United States
(12) Patent Application Publication
(10) Pub. No.: US 2026/0087577 A1
(43) Pub. Date: Mar. 26, 2026

(54) SYSTEMS AND METHODS FOR INTEGRATING COURSES GENERATED USING MACHINE LEARNING INTO A CURRICULUM

(71) Applicants: Constructor Technology AG, Schaffhausen (CH); Constructor Education and Research Genossenschaft, Schaffhausen (CH)

(72) Inventors: Sergey ULASEN, Singapore (SG); Andrey ADASCHIK, Istanbul (TR); Ilya BAIMETOV, Redmond, WA (US); Alexander TORMASOV, Busingen am Hochrhein (DE); Serg BELL, Singapore (SG); Stanislav PROTASOV, Singapore (SG); Nikolay DOBROVOLSKIY, Alanya (TR); Laurent DEDENIS, Singapore (SG)

(21) Appl. No.: 18/895,693

(22) Filed: Sep. 25, 2024

(51) Int. Cl. G06Q 50/20; G06F 3/0482; G06F 3/04847; G06F 16/34

(52) U.S. Cl. CPC G06Q 50/205; G06F 3/0482; G06F 3/04847; G06F 16/345

(57) ABSTRACT

Disclosed herein are systems and method for integrating content into a sequence using machine learning. A method may include: receiving, via a user interface (UI), content describing a topic and a plurality of sub-topics associated with the topic; executing a first machine learning model configured to determine compatibility scores between the content and a plurality of curricula; identifying at least one curriculum with a compatibility score greater than a threshold compatibility score; executing at least one other machine learning model configured to generate a modified curriculum in which the content is inserted into an original sequence of courses associated with the at least one curriculum based on prerequisites of the content and available resources to provide access to the content; and outputting, on the UI, the modified curriculum.

### FIELD OF TECHNOLOGY

The present disclosure relates to the field of machine learning, and, more specifically, to systems and methods for integrating courses generated using machine learning into a curriculum.

### BACKGROUND

In the ever-evolving landscape of education, the creation and integration of new courses into curricula are important processes that shape the academic journey of students and foster a dynamic learning environment. As educational institutions strive to adapt to emerging trends, technological advancements, and societal demands, the introduction of new courses emerges as a fundamental strategy for staying relevant and ensuring that students are equipped with the knowledge and skills necessary for success in their academic and professional pursuits.

Furthermore, the integration of new courses into curricula is not merely about expansion, but also about enrichment. It enriches the educational landscape by diversifying the range of learning opportunities available to students, catering to their varied interests, aspirations, and learning styles. By introducing new perspectives, methodologies, and content areas, institutions foster a culture of intellectual curiosity, critical thinking, and lifelong learning among their student body.

### SUMMARY

In one exemplary aspect, the techniques described herein relate to a method for integrating content into a sequence using machine learning, the method including: receiving, via a user interface (UI), content describing a topic and a plurality of sub-topics associated with the topic; executing a first machine learning model configured to determine compatibility scores between the content and a plurality of curricula, wherein each curriculum of the plurality of curricula is a sequence of courses and indicates resources utilized for each respective course in the sequence of courses; identifying at least one curriculum with a compatibility score greater than a threshold compatibility score; executing at least one other machine learning model configured to generate a modified curriculum in which the content is inserted into an original sequence of courses associated with the at least one curriculum based on prerequisites of the content and available resources to provide access to the content; and generating, for display on the UI, the modified curriculum.

In some aspects, the techniques described herein relate to a method, further including: in response to determining that the content is not compatible with any of the plurality of curricula due to a difficulty level of the content and a duration to consume the content, automatically modifying the content using a machine learning algorithm to a duration and a difficulty level associated with other content in the plurality of curricula.

In some aspects, the techniques described herein relate to a method, wherein the first machine learning model is a classification model trained using a training dataset in which each training vector includes at least text from training content and text from training curricula and indicates a corresponding compatibility score between both texts.

In some aspects, the techniques described herein relate to a method, wherein both texts include on or more objectives, topic descriptions, durations, difficulty levels, and policy information.

In some aspects, the techniques described herein relate to a method, wherein the at least one other machine learning model includes a second machine learning model configured to generate a first output sequence based on an input sequence and prerequisites of each content in the input sequence and a third machine learning model configured to generate a second output sequence based on the first output sequence and resource requirements and availability of content in the first output sequence.

In some aspects, the techniques described herein relate to a method, wherein the at least one other machine learning model generates multiple candidate curricula which includes the modified curriculum, further including: generating, for display on the UI, the multiple candidate curricula; and receiving, via the UI, a user selection of the modified curriculum.

In some aspects, the techniques described herein relate to a method, further including: receiving, via the UI, a user request to further modify the modified curriculum; and executing the user request.

In some aspects, the techniques described herein relate to a method, further including: monitoring an administration of the modified curriculum, wherein the monitoring includes collecting statistics about access and usage of the content; and executing a fourth machine learning model that recommends a modification to the modified curriculum based on the statistics. In some aspects, the techniques described herein relate to a method, wherein determining that the content is not compatible with any of the plurality of curricula due to the difficulty level is based on one or more of: expert opinion, output by a machine learning model, and monitored student performance.

In some aspects, the techniques described herein relate to a method, wherein the compatibility score can be manually changed via the UI.

It should be noted that the methods described above may be implemented in a system comprising a hardware processor. Alternatively, the methods may be implemented using computer executable instructions of a non-transitory computer readable medium.

In some aspects, the techniques described herein relate to a system for integrating content into a sequence using machine learning, including: at least one memory; and at least one hardware processor coupled with the at least one memory and configured, individually or in combination, to: receive, via a user interface (UI), content describing a topic and a plurality of sub-topics associated with the topic; execute a first machine learning model configured to determine compatibility scores between the content and a plurality of curricula, wherein each curriculum of the plurality of curricula is a sequence of courses and indicates resources utilized for each respective course in the sequence of courses; identify at least one curriculum with a compatibility score greater than a threshold compatibility score; execute at least one other machine learning model configured to generate a modified curriculum in which the content is inserted into an original sequence of courses associated with the at least one curriculum based on prerequisites of the content and available resources to provide access to the content; and generate, for display on the UI, the modified curriculum.

In some aspects, the techniques described herein relate to a non-transitory computer readable medium storing thereon computer executable instructions for integrating content into a sequence using machine learning, including instructions for: receiving, via a user interface (UI), content describing a topic and a plurality of sub-topics associated with the topic; executing a first machine learning model configured to determine compatibility scores between the content and a plurality of curricula, wherein each curriculum of the plurality of curricula is a sequence of courses and indicates resources utilized for each respective course in the sequence of courses; identifying at least one curriculum with a compatibility score greater than a threshold compatibility score; executing at least one other machine learning model configured to generate a modified curriculum in which the content is inserted into an original sequence of courses associated with the at least one curriculum based on prerequisites of the content and available resources to provide access to the content; and generating, for display on the UI, the modified curriculum.

The above simplified summary of example aspects serves to provide a basic understanding of the present disclosure. This summary is not an extensive overview of all contemplated aspects, and is intended to neither identify key or critical elements of all aspects nor delineate the scope of any or all aspects of the present disclosure. Its sole purpose is to present one or more aspects in a simplified form as a prelude to the more detailed description of the disclosure that follows. To the accomplishment of the foregoing, the one or more aspects of the present disclosure include the features described and exemplarily pointed out in the claims.

### BRIEF DESCRIPTION OF THE DRAWINGS

The accompanying drawings, which are incorporated into and constitute a part of this specification, illustrate one or more example aspects of the present disclosure and, together with the detailed description, serve to explain their principles and implementations.

FIG. 1 is a block diagram illustrating a system for generating custom courses on a user interface (UI) using machine learning.

FIG. 2 is a block diagram illustrating a system for integrating a custom course into a curriculum using machine learning.

FIG. 3A is a diagram illustrating a UI accepting a topic selection.

FIG. 3B is a diagram illustrating a UI accepting reference materials for a new topic.

FIG. 3C is a diagram illustrating the UI accepting subtopic selections.

FIG. 4A is a diagram illustrating the UI displaying a generated course.

FIG. 4B is a diagram illustrating the UI displaying an updated course based on a duration input.

FIG. 4C is a diagram illustrating the UI displaying an updated course based on a difficulty input.

FIG. 5 illustrates a flow diagram of a method for generating custom courses on a user interface using machine learning.

FIG. 6A is a diagram of an example incompatible curriculum and a custom course.

FIG. 6B is a diagram of an example compatible curriculum and a custom course integrated into a modified curriculum.

FIG. 7 is a block diagram illustrating a method for integrating a custom course generated using machine learning into a curriculum.

FIG. 8 presents an example of a general-purpose computer system on which aspects of the present disclosure can be implemented.

FIG. 9 is a block diagram illustrating a system for training course generator to generate custom courses according to aspects of the present disclosure.

### DETAILED DESCRIPTION

Exemplary aspects are described herein in the context of a system, method, and computer program product for generating custom courses on a user interface (UI) using machine learning. Those of ordinary skill in the art will realize that the following description is illustrative only and is not intended to be in any way limiting. Other aspects will readily suggest themselves to those skilled in the art having the benefit of this disclosure. Reference will now be made in detail to implementations of the example aspects as illustrated in the accompanying drawings. The same reference indicators will be used to the extent possible throughout the drawings and the following description to refer to the same or like items.

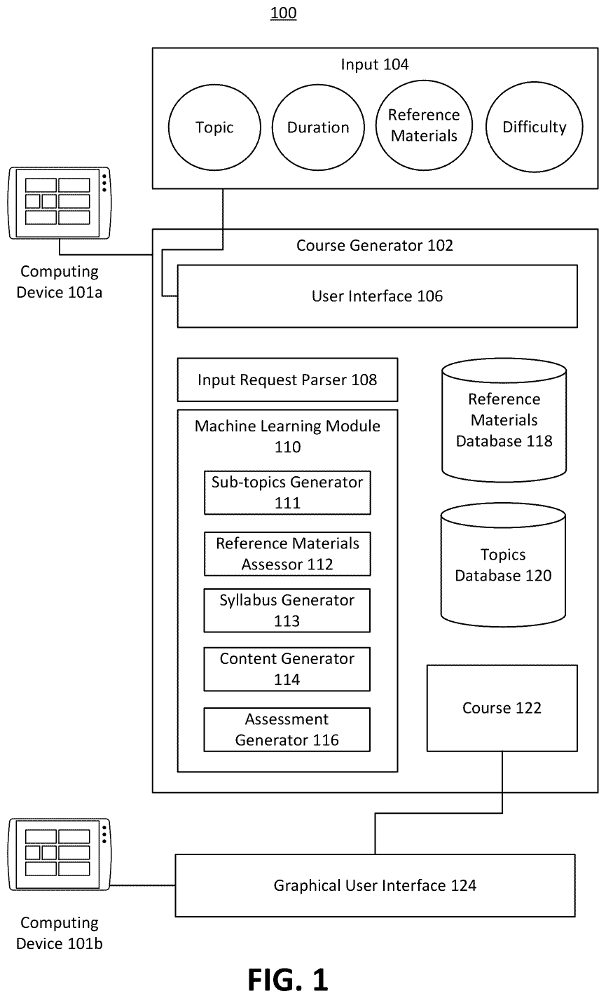

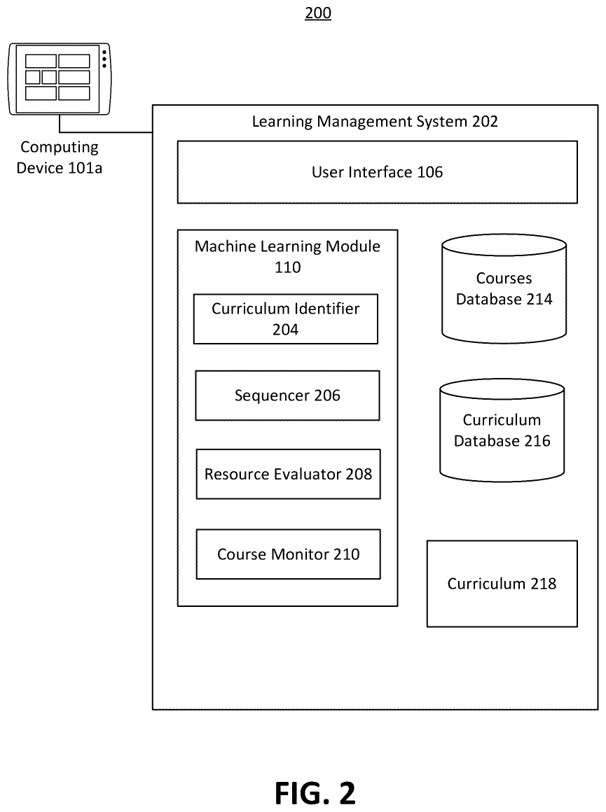

FIG. 1 is a block diagram illustrating system 100 for generating custom courses on a UI using machine learning. In particular, system 100 features course generator 102, which may be a software installed on or accessed (e.g., via a virtual machine, container, web application) on computing device 101a. Course generator 102 includes a UI 106, which is described in FIGS. 2-5, input request parser 108, machine learning module 110, reference materials database 118, and topics database 120. Course generator 102 is configured to generate course 122 for display on UI 106. Depending on user preference, course 122 may be a slide deck, a handbook, a word document, etc., and may include learning objectives, content for each sub-topic associated with a topic, etc. In some aspects, the UI may be presented via a graphical device (e.g., a graphical user interface), text terminal, chat interface, or internal chat interface by agents or similar, which can receive inputs from a user, or from another ML algorithm generated as a result of its work locally or remotely.

In some aspects, course generator 102 may transmit course 122 to user interface (UI) 124, which is part of a client application associated with course generator 102. UI 124 may be generated by computing device 101b. For example, computing device 101a may be a device belonging to an educator (e.g., a teacher, a tutor, etc.) and computing device 101b may be a device belonging to a student that is taught by the educator. Alternatively, course 122 may be generated by a student on UI 106 for self-learning.

Integrating a new course into a curriculum is a multifaceted process that requires careful planning and consideration of various factors. Such factors include educational objectives and curriculum alignment. For example, the new course should align with the overall educational goals and objectives of the curriculum. It should contribute to the development of students' knowledge, skills, and competencies in the subject area.

Another factor is sequencing. Consideration should be given to the prerequisites and sequencing of the new course within the curriculum. A course should be positioned appropriately in relation to other courses to ensure that students have the necessary foundational knowledge and skills to succeed.

Another factor is institutional regulations. An integrator should ensure compliance with institutional policies, regulations, and accreditation standards when integrating the new course. This may include considerations related to academic integrity, credit hours, grading policies, and accessibility requirements.

Another factor is resource allocation. Introducing a new course may require additional resources such as faculty expertise, instructional materials, technology, and facilities. It is essential to assess the availability of resources and plan accordingly to support the successful implementation of the course.

Another factor is long-term sustainability. An integrator should evaluate the long-term sustainability of the new course in terms of its relevance, demand, and impact on student learning outcomes. Regular reviews and revisions may be necessary to keep the course updated and responsive to evolving educational needs and industry trends.

In an exemplary aspect, based on these factors, course 122 is integrated into an academic curriculum 218 by learning management system (LMS) 202, which includes various administrative/management tools. LMS 202 may be part of the same software application as course generator 102. Once a custom course is generated, the course may be integrated using the same interface. For example, LMS 202 may share UI 106. LMS 202 also includes machine learning module 110, which includes additional machine learning models, namely, curriculum identifier 204, sequencer 206, resource evaluator 208, and course monitor 210. Machine learning module 110 may be configured to generate a new curriculum including course 122 based on outputs generated by curriculum identifier 204, sequencer 206, resource evaluator 208, and course monitor 210. For example, curriculum identifier 204 may be configured to identify one or more curricula in curriculum database 216 that are compatible with course 122 (e.g., based on topic, duration, difficulty, etc.). Sequencer 206 may be configured to output a sequence of courses in a curriculum based on prerequisite concepts needed to understand the topic/sub-topics in course 122 (e.g., to understand the distributive property in mathematics, the student must first understand multiplication, which further requires attendance in seminars, courses, laboratory work, etc.). Resource evaluator 208 may be configured to generate an updated sequence based on resources (e.g., human such as teachers, hardware such as computers, software such as teaching avatars, etc.) required for a course 122 and match the requirement with availability by the institution providing the curriculum (e.g., a mathematics teacher is needed, and the school using the course 122 has a mathematics teacher).

Course monitor 210 may collect feedback on course 122 and recommend changes. For example, course monitor 210 may collect various attributes about course 122 when it is being administered. These attributes include, but are not limited to, an amount of people that accessed the course, regular attendance, test scores, an amount of classes teaching the course, an amount of educators (e.g., teachers, avatars, assistants, etc.) per class, when the course is accessed in a period of time, whether the course is accessible online only or offline as well, and resource utilization.

Based on these attributes, course monitor 210 outputs an adjustment to the curriculum 218. In a simple example, suppose that course 122 was administered in the spring semester of a school. LMS 202 may schedule the course again in the following fall semester and specify adjusted days of the week, adjusted dates of various exam dates (e.g., final exam dates, quizzes dates, etc.) projects deadlines, etc., based on student feedback.

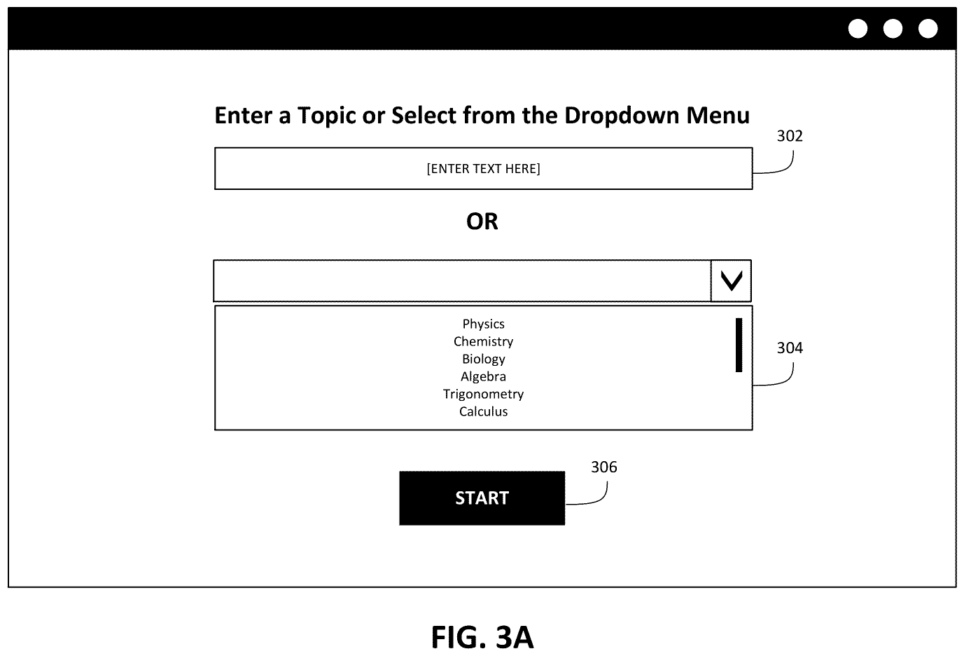

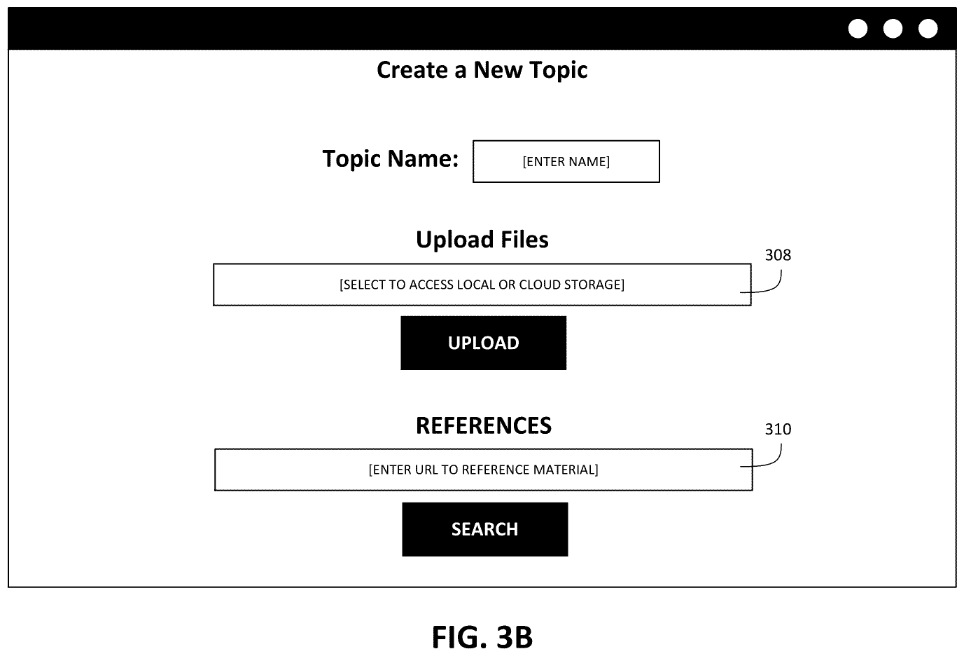

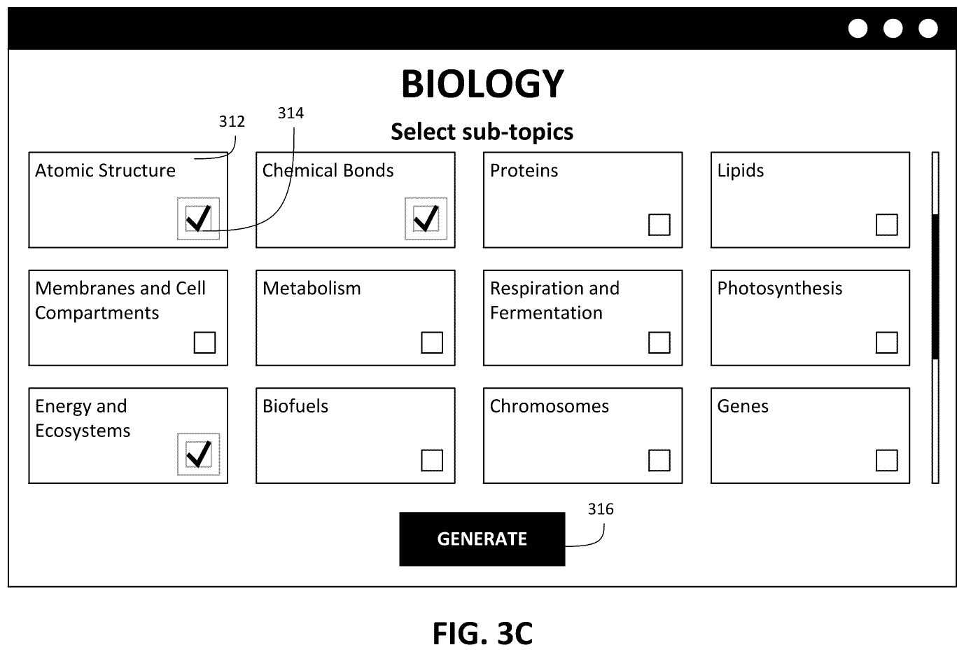

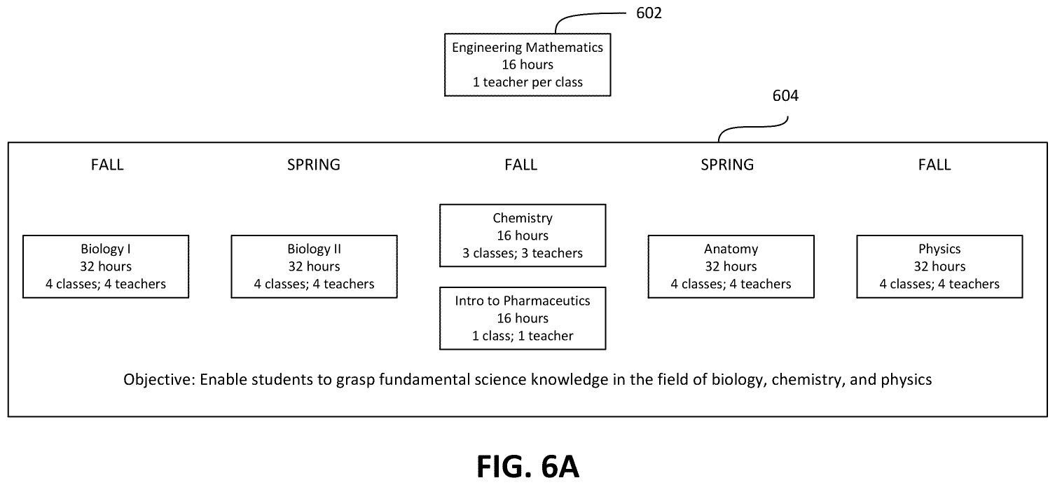

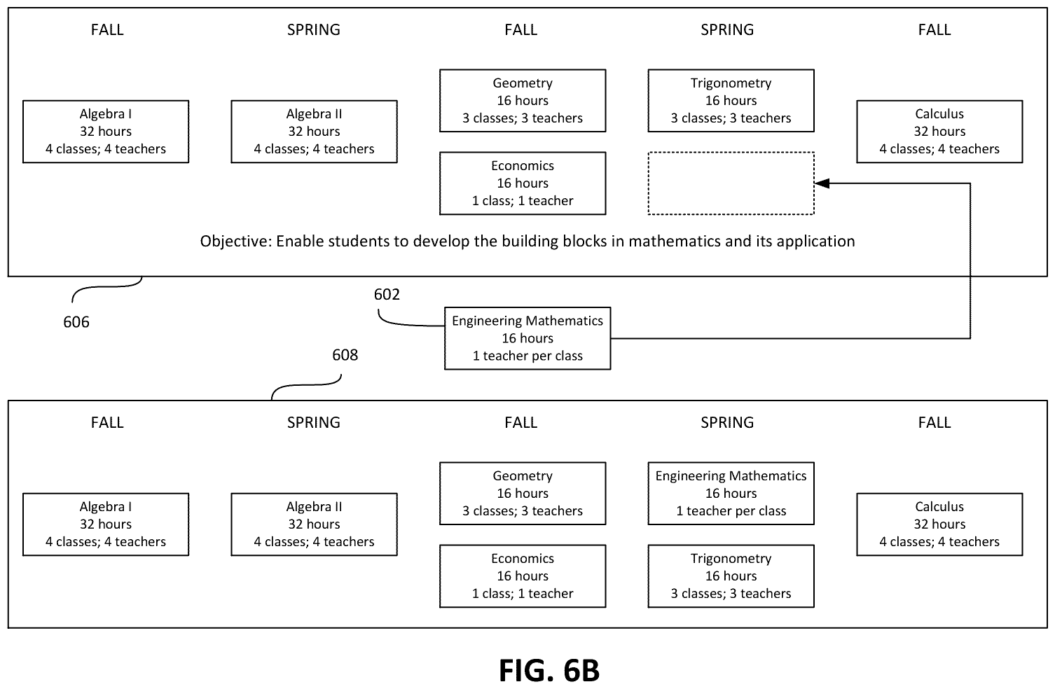

The generation of curriculum 218 by LMS 202 is further discussed in reference to FIGS. 6A and 6B. Before describing the integration of course 122 into curriculum 218, the generation of course 122 will be discussed in reference to FIGS. 3A-5. In particular, the present disclosure further discusses the use of artificial intelligence (AI) (e.g., large language models (LLM)) to create courses for teachers. For example, a teacher may indicate a topic (e.g., introduction to physics) and duration (e.g., 30 hours) of the course and may provide third party materials (e.g., textbooks, scientific papers, presentations, videos, media, etc.) to include in the course using UI 106. Machine learning module 110 comprising one or more machine learning models (e.g., sub-topics generator 111, reference materials assessor 112, syllabus generator 113, content generator 114, and assessment generator 116) may analyze the user specified sources, as well as other known sources (e.g., stored in reference materials database 118), to generate a syllabus for the course that includes various topics and subtopics. The machine learning module may further fill each lesson of the course with content generated based on the AI analysis of the source materials.

In an exemplary aspect, course generator 102 populates topics database 120. Topics database 120 includes a plurality of topics (e.g., “biology,” “chemistry,” “physics,” etc.), each of which include a plurality of sub-topics. For example, the user may provide a plurality of reference materials to course generator 102. Reference materials include, but are not limited to, textbooks, non-fiction books, webpages, e-books, videos, graphics, research papers, patents, etc. In some aspects, the user may provide, to course generator 102, a copy of the reference material(s) or may provide links to the reference material(s) for course generator 102 to web crawl. The user may label the reference materials as part of a topic. For example, the user may type in a topic in UI 106, and upload reference materials (see FIG. 3A). All provided reference materials are stored in reference materials database 118.

Given a set of reference materials for the topic, machine learning module 110 is configured to identify various sub-topics of the topic. For example, if the topic is “poetry,” a sub-topic may be a particular type of poetry or a famous poet. In order to identify the sub-topics, course generator 102 may refer to the chapter titles of the reference materials (e.g., video names, slide titles, textbook chapter titles, etc.) and identify each unique title as a sub-topic. In another approach, sub-topics generator 111 of machine learning module 110 may be used to execute an algorithm such as Latent Dirichlet Allocation (LDA).

In some aspects, input request parser 108 may clean the provided/linked text data by removing stop words, punctuation, and irrelevant characters. Input request parser 108 may further break down the cleaned text into individual words or tokens. This step prepares the data for analysis on a word level. Sub-topics generator 111 may then create a document term matrix (DTM) that represents the frequency of each term (word) in each document (e.g., textbook, webpage, etc.). Each row of the DTM may correspond to a document, and each column may correspond to a unique term, with the matrix cells including the frequency of each term in the respective document. Sub-topics generator 111 may then apply the LDA algorithm to the DTM. LDA assumes that each document is a mixture of sub-topics, and each sub-topic is a mixture of words. The algorithm iteratively assigns words to sub-topics based on the distribution of topics across documents. Furthermore, sub-topics generator 111 assigns each document a probability distribution over topics, and each word is assigned to a specific sub-topic with a certain probability. Sub-topics generator 111 may identify the most probable sub-topics for each document based on the assigned probabilities. This step involves looking at the words with the highest probability in each sub-topic and interpreting them to label the sub-topics.

Using the method described above, sub-topics generator 111 is able to identify the most common words in each topic/subtopic. Said words are stored in a glossary of the topic, which is further recorded in topics database 120. In particular, the glossary indicates multiple words and a weight of each word. The weight of the word may be determined based on a frequency at which each word appears in the reference materials. For example, for a sub-topic such as “photosynthesis” in the topic “biology,” terms such as “sunlight” and “carbon dioxide,” which appear frequently in relation to “photosynthesis” in the reference materials may be weighted higher than “night,” and “hydrogen,” which appear less frequently. For example, the weight of “sunlight” may be 1.1, while the weight of “night” may be 0.2. This suggests that in a summary, the words with higher weights should be preferred for inclusion than words with lower weights. This may be because less common words are probably specific to one textbook or niche ideas.

Reference materials assessor 112 of machine learning module 110 may also be configured to assign a quality level to each reference material in reference materials database 118. A quality level represents a reliability and general preference of a textbook as expressed in a quantitative value. For example, a university level textbook on “biology” may be a high quality material, where as a fiction novel about “biology” may be a low quality material. Assessing the quality of multiple reference materials using machine learning involves defining and extracting features that represent various aspects of a material's quality. Reference materials assessor 112 may define objective metrics (e.g., readability scores, grammatical correctness, and the complexity of sentence structures) and subjective metrics (e.g., metrics based on expert reviews, user ratings, or feedback from educators and students) for each reference material. Using these metrics, reference materials assessor 112, which may be a trained classification model, may output a quality level for each reference material. In some aspects, a quality level may be a quantitative value (e.g., a rating out of 10) or a qualitative value (e.g., “low,” “medium,” “high,” etc.).

Reference materials assessor 112 of machine learning module 110 may also be configured to assign a difficulty level to each reference material in reference materials database 118. For example, a university level textbook on “biology” may be a high difficulty material, where as an elementary school textbook about “biology” may be a low difficulty material. Reference materials assessor 112 may define metrics such as complexity of sentence structures, word length, recommended age groups, target grade level, etc., for each reference material. Using these metrics, reference materials assessor 112, which may be a trained classification model, may output a difficulty level for each reference material. In some aspects, a difficulty level may be a quantitative value (e.g., a rating out of 10) or a qualitative value (e.g., “low,” “medium,” “high,” etc.).

Course generator 102 stores reference materials and their respective quality levels and difficulty levels in reference materials database 118. It should be noted that prior to first use of course generator 102 for generating courses, the topics database 120 and reference materials database 118 needs include at least one topic and at least one reference material pertaining to the topic. A developer of course generator 102 may populate the software with multiple topics and reference materials for each topic. Afterwards, users can add topics and reference materials individually. In some aspects, topics database 120 and reference materials database 118 may be synchronized across multiple computing devices running course generator 102. For example, multiple schools or communities may share newly created topics and reference materials over a cloud database. As a result, any of a topic, reference material, course, etc., generated on one computing device may be transmitted by course generator 102 to a different computing device over a network (e.g., a local area network (LAN), a wide area network (WAN), etc.) for display on a UI.

Suppose that a user launches course generator 102 on computing device 101a to generate a course 122 on UI 106. In an exemplary aspect, UI 106 receives input 104, which may include a topic and, in some aspects, any of a duration, a difficulty, and preferred reference materials. For example, the topic in input 104 may be “biology.” Input request parser 108 may search for the topic in topics database 120. In response to finding a match, course generator 102 may output course 122 on UI 106.

A course has several means of configuration including, but not limited to, the selection of topic, selection of sub-topics, selection of reference materials, selection of duration, selection of difficulty, glossary customization, etc. In some aspects, some configurations may be set on a course level (e.g., a duration or difficulty of an entire course) and some configurations may be set on a sub-topic level (e.g., a duration of a particular lesson on a sub-topic). In response to receiving a generic input (e.g., “biology”), course generator 102 may generate course 122 using default configurations (e.g., a default set of sub-topics, difficulty, duration, etc.). In some aspects, the default configurations may be set by course generator 102 based on user preferences. For example, when creating a user profile, the user may indicate that he/she is in the 12th grade. Based on this information, course generator 102 may set the difficulty of a course to “high school” level, may set the duration to 170 hours (accounting for an hour per school day), and may use high school textbooks to generate course content.

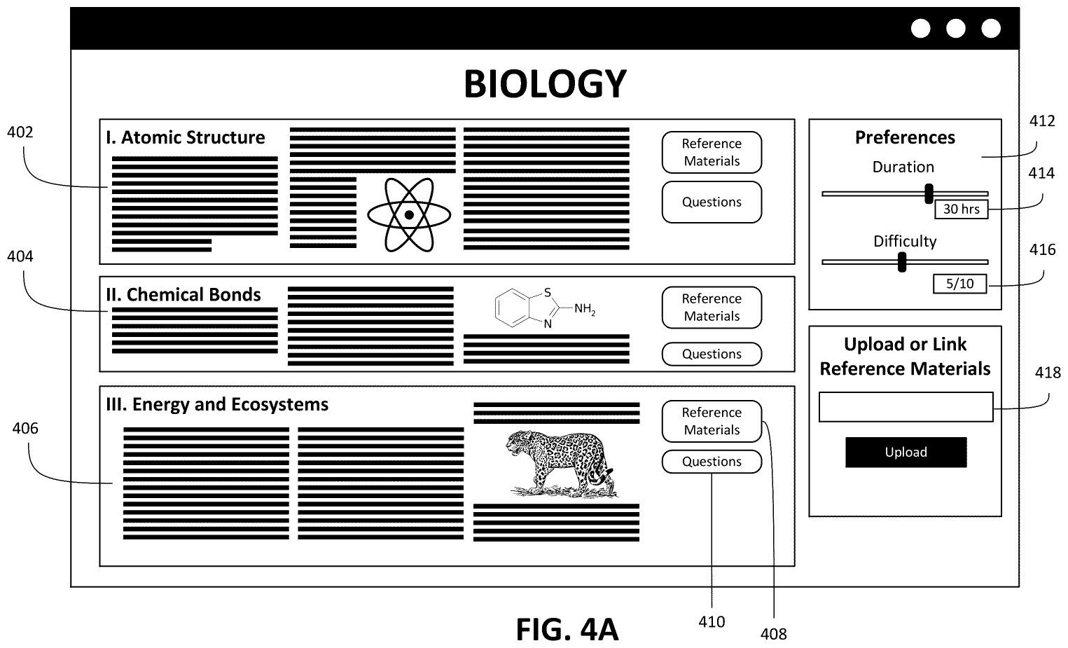

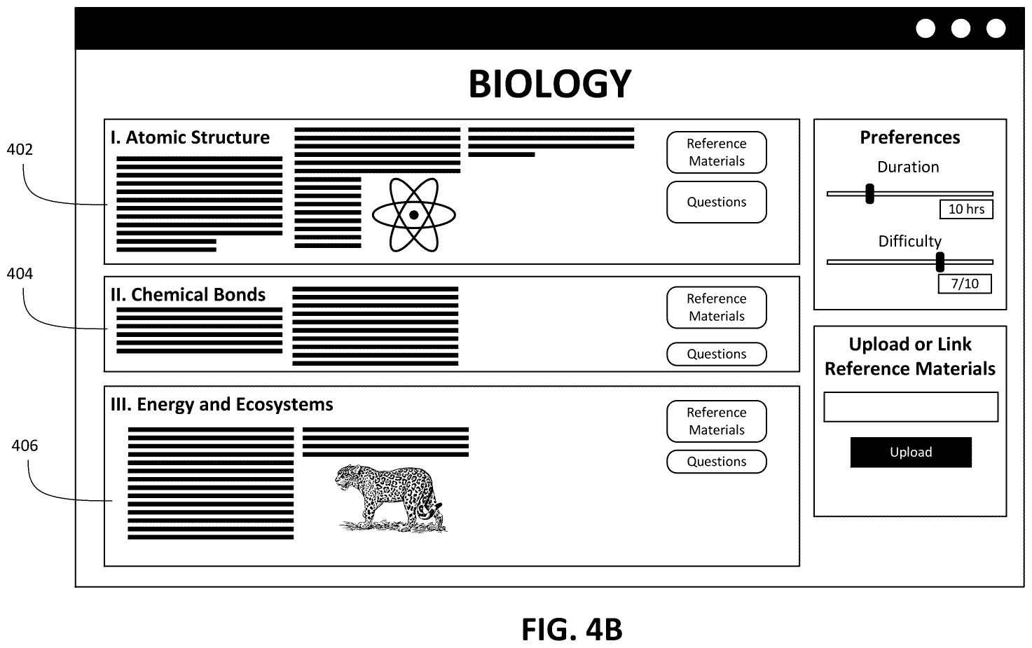

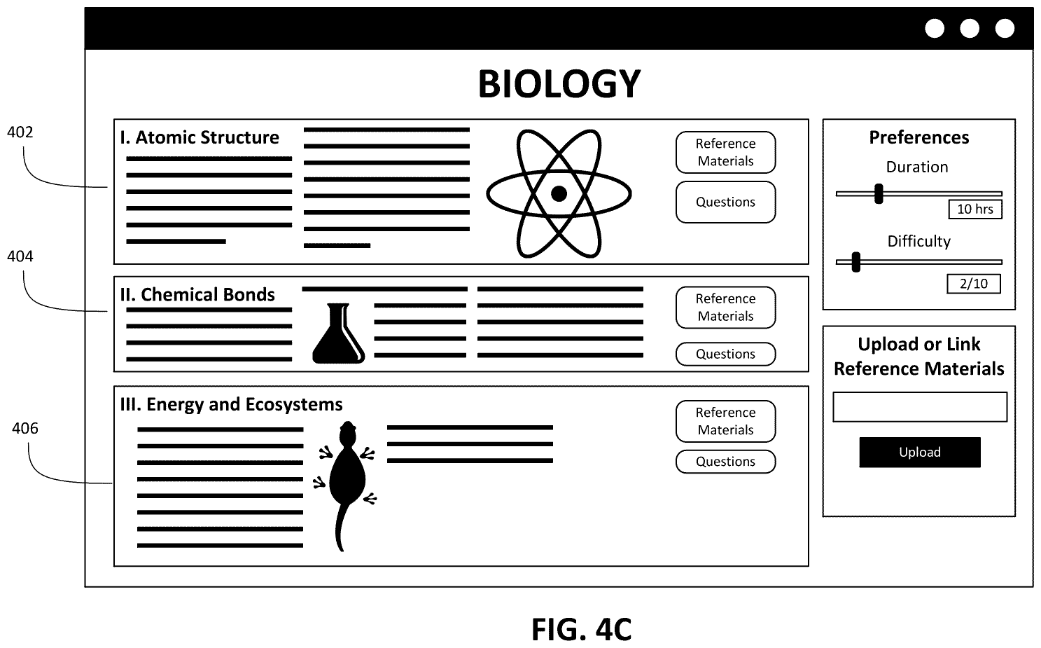

In some aspects, course generator 102 may generate queries on UI 106 to acquire more preferences by the user. For example, course generator 102 may generate a prompt that requests the user to select the sub-topics of interest (see FIG. 3). Course generator 102 may also generate panels that include configuration options (see FIG. 4A). For example, a user may be able to adjust the difficulty or duration of a course, while course generator 102 adjusts the content generated for a particular sub-topic.

In terms of course generation, syllabus generator 113 is configured to generate a structure of the course. Based on the selection of a topic, sub-topics, duration, difficulty, reference materials, etc., syllabus generator 113 outputs a plurality of course attributes. For example, the course attributes may indicate that the course has three sub-topics to be covered over nine hours on an intermediate difficulty. To achieve a nine hour duration, syllabus generator 113 allocates three hours for each sub-topic. To achieve three hours for each sub-topic, syllabus generator 113 limits a word limit of the content to 24000 (accounting for 200 word per minute reading speed), an assessment limit of 20 questions, and a media limit (e.g., a video) of 20 minutes. To achieve the difficulty constraints, reference materials matching the difficulty level are specified. For simplicity, all of these configurations are kept the same for each sub-topic in this example. However, a user may specify sub-topic level preferences, which may change these numbers. Furthermore, word limits may change based on the difficulty level as well as both duration and difficulty may affect each other. For example, at an elementary school level, the reading speed is significantly slower and comprehension skills are lower than at a university level. Accordingly, syllabus generator 113 may output lower word limits to accommodate.

In order to produce accurate structures, machine learning module 110 trains syllabus generator 113, which may be a regression model, using a training dataset that includes several input vectors and corresponding output vectors. The input vectors may each include user preference fields such as topic, sub-topic count, duration, difficulty, sub-topic level preferences, etc. The corresponding output vectors may each include course attribute fields with the ideal word limits, media limits, question limits, etc., per sub-topic. By training syllabus generator 113 to generate the output vectors based on the input vectors, syllabus generator 113 is able to recommend a plurality of course attributes for any set of course configurations provided in input 104.

Content generator 114 receives the course attributes and generates content for each sub-topic. In particular, the content comprises a summary, graphics, media, assessments (e.g., questions, projects, etc.), and recommended supplemental readings generated using one or more reference materials.

Generating summaries from multiple reference materials in reference materials database 118 using machine learning involves leveraging natural language processing (NLP) and text summarization techniques. In an exemplary aspect, content generator 114 may perform tokenization on each of the reference materials above a threshold quality level and that match a difficulty level preferred/specified by the user. Content generator 114 converts the tokenized text into numerical representations using techniques like Term Frequency-Inverse Document Frequency (TF-IDF) or word embeddings (e.g., Word2Vec, GloVe). This step captures the semantic meaning of words. In some aspects, content generator 114 may employ one or both of abstractive and extractive summarization approaches. Abstractive summarization involves generating new sentences to convey the summary, while extractive summarization selects and rearranges existing sentences.

In a supervised learning approach, content generator 114 is trained on labeled data with summaries corresponding to the reference materials. Accordingly, content generator 114 learns the relationship between the content and its corresponding summary. In an unsupervised learning approach, content generator 114 may use graph-based methods (e.g., TextRank) or clustering algorithms to identify and select the most important sentences. The length of the summary is bound to the course attribute indicated by syllabus generator 113. For example, if the word limit is 24000, the summary will include sentences extracted and/or abstracted from the reference materials that include no more than 24000 words. Because the reference materials are filtered based on quality and difficulty, content generator 114 generates tailored summaries for the user.

In an exemplary aspect, when selecting the sentences to include in the summary, content generator 114 refers to the glossary in topics database 120—specifically the glossary terms corresponding to a particular sub-topic. The weights of the words indicate which words are more important than others. Thus, the sentences extracted from reference material are likely to include words with higher weights. Likewise, self-generated sentences are likely to include words with higher weights. In some aspects, a user may access the glossary and adjust weights. In fact, a user may opt to add words and remove words depending on their learning preferences.

In some aspects, the extracted sentences from the reference materials may include mentions of graphics. For example, a textbook passage may refer to a textbook image. Accordingly, content generator 114 includes the mentioned graphic in the generated content. In another example, a website may include a link to a video on a video streaming website. Accordingly, content generator 114 includes the link to the video in the generated content.

Assessment generator 116 is configured to generate one or more of questions, short quizzes, tests, lab projects, etc., based on the generated content. For example, assessment generator 116 may be a generative neural network that receives the summary generated by content generator 114 and creates questions with answers found in the summary. If the summary says “the mitochondria is an organelle in which respiration and energy production occur,” assessment generator 116 may generate the question “which organelle is responsible for respiration and energy production?”. In some aspects, assessment generator 116 may identify questions found in the reference materials associated with the sub-topic. For example, if the summary includes information about the mitochondria, assessment generator 116 may identify a question in the reference material about the mitochondria. In some aspects, assessment generator 116 compares the sentences in the summary to the sentences in the questions. Based on a correspondence, assessment generator 116 determines whether the question is a candidate for inclusion in the generated content. It should be noted that the number of questions or types of assessments produced by assessment generator 116 is indicated in the course attributes generated by syllabus generator 113.

In some aspects, course generator 102 is equipped with sophisticated feedback algorithms that actively monitor student progress and adapt the generated content in real-time. The feedback algorithms recognize areas where students excel or struggle (e.g., like in differentiating between their grasp on derivatives and integrals in calculus). Based on this insight, course generator 102 may proactively offer supplementary modules, interactive tutoring sessions, or even adjust the main course content to better suit the student's learning pace and style. These real-time adjustments are powered by an intricate analysis of student performance, feedback, and learning patterns-ensuring that each student's learning journey is as effective and personalized as possible.

Course generator 102 of the present disclosure is an improvement in computer technology-particularly with regard to GUIs. A traditional user interface may display the content found in a reference material (e.g., generate a web page), but fails to limit the amount of information shown based on specific user preferences such as duration, difficulty, sub-topic preference, etc. Course generator 102 is configured to generate an improved UI that presents information that is relevant to the user and automatically updates as the user's preferences are updated.

In general, machine learning module 110 may comprise one or more machine learning algorithms, which can broadly be categorized into three main types: supervised learning, unsupervised learning, and reinforcement learning.

Supervised learning is effective for tasks such as classification (assigning inputs to predefined categories) and regression (predicting continuous values). It relies on the availability of labeled data for both training and evaluation phases. In supervised learning, machine learning module 110 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, machine learning module 110 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, machine learning module 110 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine learning module 110 refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem.

Unsupervised learning is valuable for tasks where the goal is to explore the inherent structure of the data, identify hidden patterns, or pre-process data for further analysis. It doesn't require labeled examples but relies on the algorithm's ability to discern meaningful structures within the input data. Unsupervised learning deals with unlabeled data, aiming to discover patterns, structures, or relationships within the dataset. Clustering and dimensionality reduction are common tasks in unsupervised learning, helping to reveal inherent structures without predefined target labels. The typical process for unsupervised learning includes: data collection, analysis (e.g., using clustering, dimensionality reduction, etc.) and association. For example, machine learning module 110 receives a dataset including only input features without corresponding output labels. Machine learning module 110 then performs exploratory data analysis to understand the inherent structure of the data. Common techniques in this analysis include statistical measures, clustering, and dimensionality reduction. For example, in clustering, the algorithm groups similar data points together based on certain features. Algorithms including, but not limited to, k-means clustering and hierarchical clustering are commonly used for grouping. In dimensionality reduction, the algorithm reduces the number of input features while retaining essential information. For example, the algorithm may use techniques like Principal Component Analysis (PCA) or t-distributed Stochastic Neighbor Embedding (t-SNE) for dimensionality reduction. During the association phase, the algorithm discovers relationships or associations between variables in the analyzed data. In some aspects, unsupervised learning is used in generative neural networks (e.g., generative adversarial networks (GANs)) to generate new data points similar to the existing dataset once the characteristics of the existing dataset are learned.

Reinforcement learning is applied in scenarios where the optimal decision-making strategy is learned through trial and error, without explicit guidance. It finds applications in various domains, including robotics, game playing, and autonomous systems. More specifically, reinforcement learning involves an agent learning to make decisions by interacting with an environment. The agent receives feedback in the form of rewards or penalties based on its actions, allowing it to learn optimal strategies through trial and error. The primary components of reinforcement learning are as follows: agent, environment, state, action, reward, exploration and exploitation, learning policy, and value function. An agent is the entity that takes actions in the environment. It's the learner in the system. The environment is the external system with which the agent interacts. It provides feedback to the agent based on the actions taken. The state is a representation of the current situation or configuration of the environment. Actions are the moves or decisions that the agent can take within the environment. A reward is a numerical signal that indicates the immediate benefit or cost of the agent's action. The agent's objective is to maximize the cumulative reward over time. The reinforcement learning process typically involves the following steps. The agent explores the environment to discover the most rewarding actions (exploration) and exploits its current knowledge to take actions it believes will yield the highest cumulative reward (exploitation). The agent learns a policy, which is a strategy that maps states to actions, based on the observed rewards and its exploration-exploitation trade-offs. The agent may also learn a value function, estimating the expected cumulative reward from a given state or state-action pair.

In machine learning, training involves optimizing the model's parameters to minimize a chosen objective function, often a loss function. Some training formulas and concepts that machine learning module 110 may execute include linear regression loss, logistic regression loss, reinforcement learning, and neural network loss.

For linear regression, Mean Squared Error (MSE) is a common loss function.

$$MSE = \frac{1}{n} {\sum }_{i = 1}^{n} {( {y}_{i} - {\hat{y}}_{i} )}^{2}$$

where yi is the true output, y\hat{ }i is the predicted output, and n is the number of samples.

For binary classification in logistic regression, the Binary Cross-Entropy Loss is frequently used.

$$Binary Cross ‐ Entropy = - \frac{1}{n} {\sum }_{i = 1}^{n} [ {y}_{i} log ( {\hat{y}}_{i} ) + ( 1 - {y}_{i} ) log ( 1 - {\hat{y}}_{i} ) ] ,$$

where yi is the true label (0 or 1), y\hat{ }i is the predicted probability, and n is the number of samples.

In neural networks, the cross-entropy loss is common for classification tasks. Cross-

$$Entropy = - \frac{1}{n} {\sum }_{i = 1}^{n} {\sum }_{j = 1}^{C} {y}_{ij} log ( {\hat{y}}_{ij} ) ,$$

where yij is the true probability of class j, y\hat{ }ij is the predicted probability, n is the number of samples, and C is the number of classes.

In reinforcement learning, the objective is often to maximize the expected cumulative reward. The Q-learning update rule is an example:

$$Q ( s , a ) ← Q ( s , a ) + α [ r + γ {max}_{{a}^{′}} Q ( {s}^{′} , {a}^{′} ) - Q ( s , a ) ] ,$$

where Q(s,a) is the action-value function, a is the learning rate, r is the immediate reward, γ is the discount factor, s′ is the next state, and a′ is the next action.

These formulas represent the core optimization objectives in different machine learning scenarios, and the choice depends on the specific task and model architecture.

Machine learning module 110 may comprise one or more neural networks, which are a class of machine learning models inspired by the structure and functioning of the human brain. They consist of interconnected nodes, called neurons or artificial neurons, organized into layers. Neural networks are capable of learning complex patterns and representations from data. The neural network executed by machine learning module 110 may be one of the following: a feedforward neural network (FNN), convolution neural network (CNN), recurrent neural network (RNN), long short-term memory (LSTM) network, gated recurrent unit (GRU) network, autoencoder, generative adversarial network (GAN).

An FNN is the simplest form of neural network, where information travels in one direction-from the input layer through hidden layers to the output layer. An FNN is commonly used for tasks like classification and regression.

A CNN is specialized for processing grid-like data, such as images, and employs convolutional layers to learn spatial hierarchies of features, reducing the need for manual feature engineering. CNNs are well-suited for tasks like image classification, object detection, and image generation.

An RNN is designed for sequential data, where the order of inputs matters. An RNN includes loops in the network architecture to allow information to persist, and is useful for tasks like natural language processing, speech recognition, and time-series prediction.

A LSTM network is an extension of an RNN designed to overcome the vanishing gradient problem. LSTMs have memory cells that can store and retrieve information over long sequences, making them effective for capturing long-term dependencies in sequential data.

A GRU Network is similar to LSTMs and are another type of RNN with mechanisms to address the vanishing gradient problem. GRUs have a simpler architecture with fewer parameters compared to LSTMs.

An autoencoder is a type of neural network used for unsupervised learning and dimensionality reduction, and consists of an encoder that compresses input data into a lower-dimensional representation (encoding) and a decoder that reconstructs the original input from the encoding.

A GAN comprises a generator and a discriminator trained simultaneously through adversarial training. The generator aims to generate realistic data, while the discriminator tries to distinguish between real and generated data. A GAN is widely used for image and content generation tasks.

FIG. 3A is a diagram illustrating a UI accepting a topic selection. The UI in FIG. 3A corresponds to UI 106 generated on computing device 101a. UI 106 (as shown in FIG. 3A) displays text stating “enter a topic or select from the dropdown menu” and provides two input options right below. UI 106 may receive a text input in textbox 302 (e.g., the user may enter the text “Biology”) or may receive a selection from the plurality of topics listed in menu 304 (e.g., the user may scroll through the menu and select “Biology”). UI 106 receives confirmation of the selection via the selection of the “start” button 306.

FIG. 3B is a diagram illustrating a UI accepting reference materials for a new topic. UI 106 (as shown in FIG. 3B) displays text stating “create a new topic,” and provides field 308 where a user may upload reference materials. For example, UI 106 may receive a collection of slide deck(s), text document(s), graphic(s), etc., that are uploaded by the user from a local storage (e.g., a local hard drive) or a cloud storage (e.g., an online data storage service). Additionally or alternatively, the user may provide Internet-based links (e.g., URL) to said references via field 310.

FIG. 3C is a diagram illustrating the UI accepting subtopic selections. UI 106 (as shown in FIG. 3C) generates a plurality of sub-topics to include from the selected topic. For example, if UI 106 receives a selection of “biology,” reference materials assessor 112 may extract the corresponding sub-topics from topics database 120. In FIG. 3C, examples of sub-topics include “atomic structure,” “chemical bonds,” “proteins,” “lipids,” etc. Each sub-topic may be listed in a dropdown menu or as a table with multiple selectable elements. For example, in FIG. 3C, UI 106 presents the sub-topics as elements such as element 312 that includes a selection indicator 314. When the user selects a selection indicator 314 for a particular element, a graphic indicative of selection may be generated (e.g., a checkmark in the checkbox). After the user is satisfied with his/her selection(s), the user may select the “generate” button 316 to confirm the selection.

FIG. 4A is a diagram illustrating the UI displaying a generated course. Subsequent to receiving selections of the topic and sub-topic, UI 106 generates a course that includes an initial syllabus and initial course content. For example, factors such as duration and difficulty may be default values such as 30 hours and 5/10, respectively. As shown in FIG. 4A, UI 106 displays panels 402, 404, and 406. Each panel is ordered in the manner indicated by the generated syllabus (e.g., “atomic structure,” followed by “chemical bonds,” followed by “energy and ecosystems”). Each panel includes course content, which includes any combination of text, graphics (e.g., images, videos, animations, etc.), interactive plug-ins (e.g., games, etc.), etc., extracted from the reference materials associated with the sub-topics. Each panel further includes reference materials button 408, which allows a user to access the reference materials directly, and may indicate the portions that the user is recommended to read/view/listen to in the reference materials. For example, the user may review panel 406, which includes the course content generated by content generator 114. The user may then select reference materials button 408, which directs the user to a website that includes recommended supplemental material to learn more about the sub-topic. Likewise, UI 106 may receive a selection of questions button 410, which results in an output of questions generated by assessment generator 116.

In an exemplary aspect, UI 106 displays preferences panel 412, which allows the user to customize the course displayed on UI 106. For example, a user may adjust the duration associated with the course by entering a duration value in duration adjuster 414 (e.g., the user may enter a text input or slide the slider). The user may also adjust the difficulty of the course by entering a difficulty value in difficulty adjuster 416. The effects of changing course duration are seen by comparing FIG. 4A and FIG. 4B. The effects of changing course difficulty are seen by comparing FIG. 4B and FIG. 4C.

Lastly, the user may upload the reference material that he/she would like to incorporate in the content generated by content generator 114. For example, the user upload a slide deck via panel 418. Accordingly, the text, graphics, etc., shown in the panels 402, 404, and 406 may dynamically change to incorporate the contents of the uploaded slide deck. Similarly, the user may provide an Internet-based link to the reference material via panel 418.

FIG. 4B is a diagram illustrating the UI displaying an updated course based on a duration input. As shown in FIG. 4A, UI 106 displays the course comprising panels 402, 404, 406, and options for each panel via buttons such as buttons 408 and 410. As the user makes adjustments to the course using panels 412 and 418, UI 106 is dynamically updated. In particular, data that is not relevant or does not accommodate the user's preferences is automatically hidden, whereas data that is relevant and accommodates the user's preferences is highlighted. In FIG. 4A, the duration of the course is set to 30 hours. In FIG. 4B, UI 106 receives an adjustment that sets the duration to 10 hours. Accordingly, UI 106 dynamically updates such that fewer text is shown. More specifically, the content from the references materials is summarized in a manner that fewer words are used to describe the sub-topic, fewer questions are included in assessments, and not as many reference materials are recommended. As a result, the user spends less time learning the information.

FIG. 4C is a diagram illustrating the UI displaying an updated course based on a difficulty input. For example, in FIG. 4B, the text is reduced and the sub-topic is summed in fewer words. However, the difficulty remains constant. In FIG. 4C, UI 106 receives an adjustment that sets the difficulty from 5/10 to 2/10 (e.g., making it easier to understand). As shown in panels, 402, 404, and 406, even less text is used and the images are slightly different (e.g., more cartoon-like). The difficulty may be adjusted slightly by explaining concepts in layman terms with simpler words (e.g., using the word “hard” instead of “challenging”). Alternatively, the difficulty may be adjusted greatly by using different reference materials to generate the content (as shown in FIG. 4C). For example, instead of using a university-level textbook, UI 106 may display content summarized from an elementary school textbook covering the same sub-topic.

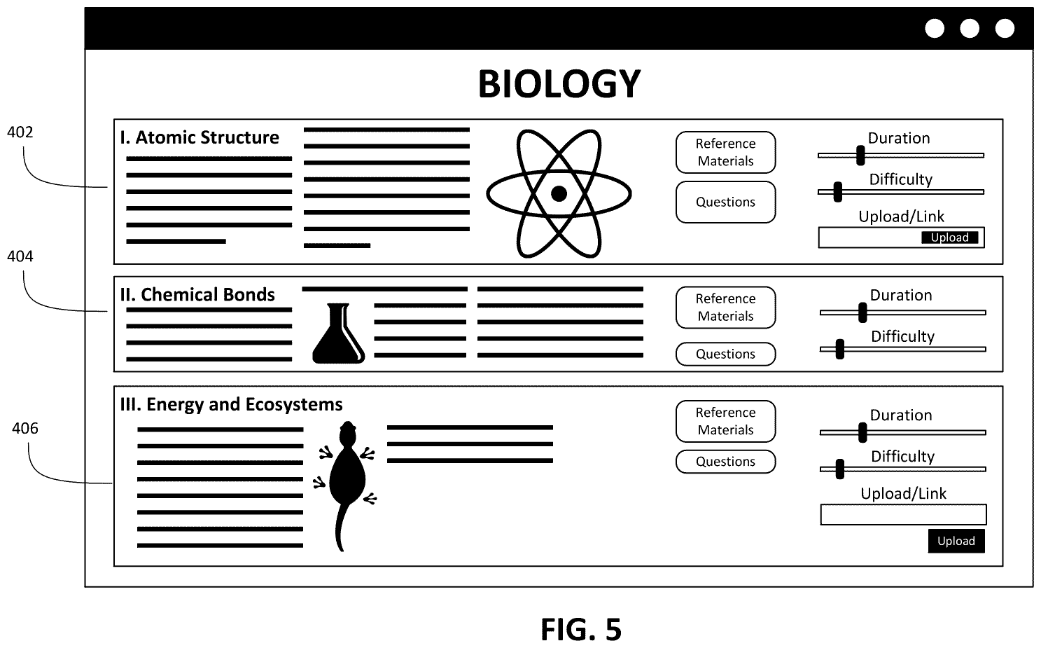

FIG. 5 is a diagram illustrating the UI configuration options for the content generated for each sub-topic. As shown in FIG. 5, in each of panels 402, 404, 406, UI 106 may display the options shown in panels 412 and 418. For example, the user may not be interested in adjusting the difficulty, reference materials, and/or duration of all courses globally, or may have preferences for each specific sub-topic. In some aspects, the user may indicate a particular difficult, duration, and/or reference material for each sub-topic, and UI 106 may update the content automatically based on the selection. For example, the user may want to cover the topic of “atomic structure,” in two hours on an easier difficulty because the user or a student of the user does not understand the subject as easily as other sub-topics. In contrast, the user may want to spend only 30 minutes learning about “energy and ecosystems,” and is comfortable on an intermediate difficulty setting. The user may even upload specific reference materials for a specific sub-topic such as “energy and ecosystems,” or may link an e-book and specify pages (e.g., a chapter associated with “energy and ecosystems”) to extract/summarize information from.

Traditional user interfaces (UIs) have long served as the primary means of presenting educational content, attempting to bridge the gap between information and learners. However, the shortcomings of conventional UIs in effectively displaying educational content have become increasingly evident. As the demand for dynamic and engaging learning experiences rises, these interfaces often struggle to provide the necessary flexibility, interactivity, and adaptability required to meet the diverse needs of modern learners. In this era of digital education, the limitations of conventional UIs hinder the seamless delivery of educational material, impeding the potential for enhanced comprehension and retention.

From a computer perspective, conventional user interfaces (UIs) encounter several deficiencies when attempting to display educational content effectively. These limitations stem from the inherent design principles and constraints associated with traditional interfaces. For example, traditional UIs are often static, presenting educational content in a fixed format. This lack of dynamism limits the adaptability of interfaces to diverse learning styles and inhibits the seamless integration of media elements.

Most conventional UIs offer limited interactivity. Learners are often confined to passive consumption of content, with minimal opportunities for active engagement. Navigation within traditional UIs may become cumbersome when dealing with extensive educational content. Cumbersome navigation impedes the fluid movement between sections, hindering users from quickly accessing relevant information. For example, several relevant pieces of information and options are often hidden behind menus and involve sub-optimal interaction to reach.

FIG. 6A is a diagram of an example incompatible curriculum and a custom course. FIG. 6B is a diagram of an example compatible curriculum and a custom course integrated into a modified curriculum. Suppose that using the techniques described above, a custom course 602 covering the topic “engineering mathematics” is generated by course generator 102. LMS 202 is configured to integrate course 602 into a curriculum in curriculum database 216. For example, the course may be for university level students. The institution may offer a variety of majors such as mathematics, biology, engineering, etc. Each major may have its own curriculum. It should be noted that the example curriculums described in the present disclosure are highly simplified. A given curriculum may feature several courses, although only a few are shown for simplicity. A curriculum may outline the structure of multiple courses (e.g., an order of courses based on prerequisites), when courses are available (e.g., fall semester, summer semester, etc.), a number of available classes in a given time, an amount of resources available per class in which the course is taught, and an objective of the curriculum. For example, referring to FIG. 6A, curriculum 604 includes 6 science-oriented courses and lists when the courses are administered, the number of classes, the number of total teachers available to teach the course in a class of students, and an objective.

LMS 202 may execute curriculum identifier 204 to determine a compatibility score between a plurality of curriculums in curriculum database 216 and course 602. The output of curriculum identifier 204 may be a vector that lists each of the plurality of curriculums and a respective compatibility matrix. For example, the output vector may be:

| | Compatibility |
|---|---|
| Curriculum | Score |
| Mathematics Major | 9/10 |
| Science Major | 6.5/10 |
| . . . | . . . |
| Computer Science | 6/10 |

In this output vector, science major may refer to curriculum 604 and mathematics major may refer to curriculum 606. Curriculum identifier 204 may be a classification model that may use various approaches to determine the compatibility score. In one aspect, curriculum identifier 204 may compare the text in course 602 with an objective of the curriculum. In some aspects, course 602 may have its own objective or genre that is compared against an objective or genre of a curriculum.

In another aspect, curriculum identifier 204 may compare the text in course 602 with other courses that are part of a curriculum. Initially, the texts may undergo preprocessing steps such as tokenization, stop-word removal, and stemming or lemmatization to standardize their representation. Then, features are extracted from the texts, which could include word embeddings, bag-of-words representations, or TF-IDF scores. These features capture semantic and syntactic information from the texts. Subsequently, a similarity metric like cosine similarity, Jaccard similarity, or edit distance may be applied by curriculum identifier 204 to quantify the degree of resemblance between the feature representations of the two texts. The resulting compatibility score reflects whether a course can be integrated into a curriculum, with higher scores indicating greater similarity or compatibility between the texts. Curriculum identifier 204 may further be trained and fine-tuned to produce this compatibility score using machine learning methods.

In particular, curriculum identifier 204 may also receive course attributes such as duration and difficulty. In FIG. 6A, each course is shown to be taught over a semester. Suppose that the semester includes 16 weeks. Certain courses require two hours per week, whereas other courses require one hour per week. If the generated course is 18 hours, which is two hours too many, the course may not be compatible with the curriculum. Similarly, if the course difficulty is at a high school level and the curriculum is taught in a university, the course may not be compatible with the curriculum. If the compatibility scores are too low for all curricula (e.g., due to duration and difficulty incompatibility), curriculum identifier 204 may automatically adjust the course through course generator 102.

As shown in FIGS. 6A and 6B, and the output vector given in the example, course 602 is incompatible with curriculum 604, but is compatible with curriculum 606. In some aspects, curriculum identifier 204 determines this compatibility by using a threshold compatibility score (e.g., 8/10). If a compatibility score is greater than the threshold compatibility score, the curriculum is a candidate for integrating the course in. In some cases, multiple curricula may have compatibility scores greater than the threshold compatibility score. In this case, there are multiple candidates for curriculum identifier 204 to choose from. For example, there may be curricula such as engineering, mathematics, and data statistics that are compatible with course 602. Depending on additional factors such as available resources and feedback, the integration may be performed on a subset of the candidate curricula.

Sequencer 206 is configured to identify an order in which the course should be integrated. In curriculum 606, students take algebra I, then algebra II, and then geometry and/or economics. In order to understand the concepts in geometry and economics, it is assumed that the student needs to know algebra. Similarly, in order to comprehend the content in course 602, a student needs to be equipped with certain skills and have a base knowledge. For example, the student should know algebra and geometry. The earliest that course 602 may then be administered is after geometry. Furthermore, sequencer 206 considers whether course 602 includes concepts that are prerequisites for other courses in the curriculum. For example, course 602 may teach certain sub-topics that may aid a user in understanding calculus (e.g., may include some pre-calculus concepts such as limits). Based on this information, sequencer 206 may determine that course 602 may be set for students after taking geometry and before taking or alongside calculus.

On a technical level, sequencer 206 may be trained on a dataset where each instance represents a course sequence, with features encoding the courses and their prerequisites, and the target variable representing the desired outcome, such as successful completion of the curriculum. Preprocessing steps may involve encoding the courses (e.g., algebra I=1, algebra II=2, etc.) and prerequisites into numerical representations (e.g., algebra I is prerequisite of algebra 2 being defined as 2-1). Sequencer 206 may be one of a decision tree, a sequence-to-sequence model, or a reinforcement learning algorithm, specifically configured to learn the relationships between courses and their prerequisites.

During training, sequencer 206 adjusts its parameters to minimize prediction errors and optimize the sequence of courses based on the provided prerequisites. For example, the training dataset may include at least one training vector of a respective course and a respective curriculum. The prerequisite concepts, which can be extracted using natural language processing, for each course may be included in the input. The pre-labeled output of the training vector maybe an ideal sequence. Using these training vectors as references, sequencer 206 may output one or more sequences for each input. For example, if course 602 and curriculum 604 are inputted into sequencer 206, sequencer 206 may generate a first sequence in which course 602 is administered in the same semester as trigonometry and a second sequence in which course 602 is administered in the same semester as calculus. Sequencer 206 may generate several permutations so long as the prerequisite requirements are satisfied.

Subsequently, resource evaluator 208 determines an updated sequence based on resources available at a given time. For example, a course may require resources such as a teacher, a laptop, lab equipment, a teaching assistant, a teaching avatar, etc. For simplicity, suppose that only a teacher is needed for course 602. Furthermore, suppose that each curricula includes statistics about available resources and required resources. For example, there may be a total of four mathematics teachers in an institution. Each of these teachers may teach at most one class. As mentioned before, there are two placement options determined by sequencer 206. The first involves teaching course 602 in the spring semester with trigonometry. The second involves teaching course 602 in the fall semester with calculus. Resource evaluator 208 may determine that the four teachers available for teaching are each teaching calculus in the fall semester. Thus, there are no more required resources available during that time. In contrast, in the spring semester, there is one teacher who is not teaching a course. Accordingly, there is one resource available and the sequence is a better fit in terms of integration.

It should be noted that the example given above is highly simplistic. There are many types of resources and each resource has a certain level of importance. For example, a resource such as a teacher may have an importance level of 9/10, whereas a resource such as a laptop may have a resource like 7/10. Furthermore, resource importance and availability may change over time. For example, teachers may be let go, new staff may join, hardware may be unavailable due to IT issues, etc. Resource evaluator 208 is trained to generate a sequence based on an input course sequence and projected resources for a particular time period. Similar to sequencer 206, resource evaluator 208 may be a sequence-to-sequence model or a decision tree.

As shown in FIG. 6B, resource evaluator 208 ultimately outputs curriculum 608, which is a variation of curriculum 606. It should be noted that resource evaluator 208 may create other sequence options in which the resource requirements are met. For example, there may be another output sequence in which the engineering mathematics course replaces the economics course based on resource availability (e.g., economics is moved out of the curriculum because it does not meet the objective of the curriculum, or is pushed to another semester). LMS 202 may store these variations in curriculum database 216.

Course monitor 210 is configured to recommend changes to a curriculum. For example, if curriculum 608 is not effective based on a semester, course monitor 210 may recommend instituting the sequence, stored in curriculum database 216, in which course 602 is taught in place of economics. For example, if not enough students sign up for a class (e.g., less than a threshold amount) for course 602, there may be little interest in the course. Thus, wasting resources on course 602 may not be ideal and the course may be replaced in further iterations of the curriculum. Similarly, if resource requirements for a course turn out to be under/over requested, the resources allocated for the course may be changed or the sequence of the curriculum may be changed. For example, the course may originally indicate requiring certain lab equipment for each student, but during an actual class, the teacher may determine that the lab equipment is not needed to teach an associated sub-topic. Course monitor 210 may receive teacher/student feedback, each comprising text describing how the teacher/students feel about the course. For example, a student may indicate that the course is extremely difficult and needs to be divided into two semesters (as shown for algebra in FIG. 6A) to have more time to learn each sub-topic. The feedback may also include information such as class attendance, class test scores, project grades, etc., to determine how students performed.

With this feedback as an input, course monitor 210 may be configured to recommend a new sequence for the curriculum relative to course 602. For example, the new sequence may divide the course into multiple semesters, may indicate additional resource allocations, may change the order of courses, etc., to address the issues highlighted in the feedback (if any). In some aspects, course monitor 210 may function as a reinforcement learning algorithm in which certain changes are executed and evaluated over a long period of time.

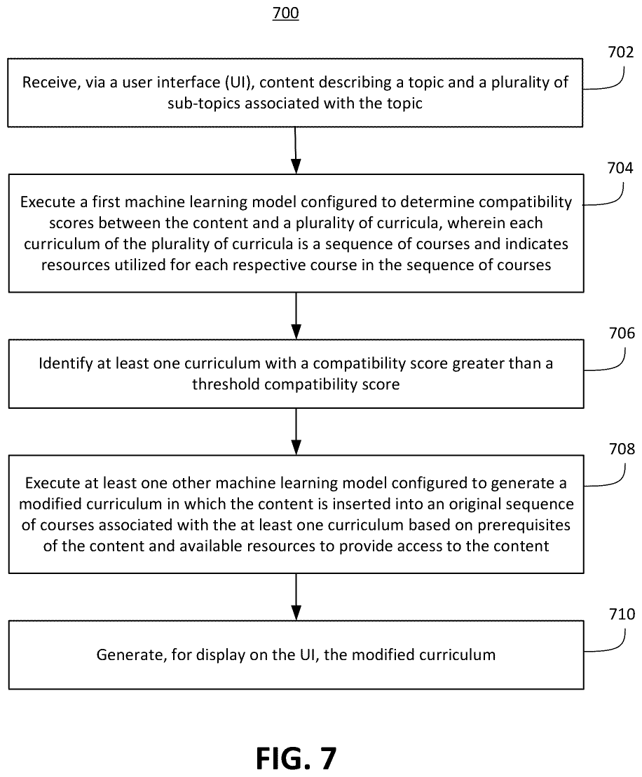

FIG. 7 is a block diagram illustrating method 700 for integrating a custom course generated using machine learning into a curriculum. At 702, LMS 202 receives, via a UI 106, content describing a topic and a plurality of sub-topics associated with the topic. For example, the content may be course 122 or course 602. An example of the content may look like on UI 106 is shown in FIG. 5.

At 704, LMS 202 may execute a first machine learning model configured to determine compatibility scores between the content and a plurality of curricula. For example, the first machine learning model may be curriculum identifier 204. Each curriculum of the plurality of curricula (which may be stored in curriculum database 216) is a sequence of courses and indicates resources utilized for each respective course in the sequence of courses.

In some aspects, the first machine learning model is a classification model trained using a training dataset in which each training vector comprises at least text from training content and text from training curricula and indicates a corresponding compatibility score between both texts. In some aspects, both texts comprise one or more objectives, topic descriptions, durations, difficulty levels, and policy information. For example, the first machine learning model may compare an objective of the content with an objective of a given curriculum to determine compatibility.

In some aspects, in response to determining that the content is not compatible with any of the plurality of curricula due to a difficulty level of the content and a duration to consume the content, LMS 202 may automatically modify the content using a machine learning algorithm to a duration and a difficulty level associated with other content in the plurality of curricula. For example, LMS 202 may use one or more machine learning models of course generator 102. An example modification is shown in reference to FIGS. 4A-4C. For example, if one other content is 16 hours long and the current duration of the content is 20 hours, LMS 202 may reduce the duration of the content to 16 hours (to match the other content already in place of curricula).

At 706, LMS 202 identifies at least one curriculum with a compatibility score greater than a threshold compatibility score. For example, the compatibility score may be 9/10 and the threshold compatibility score may be 8.5/10. It should be noted that the compatibility score may be any quantitative (e.g., fraction, percentage, integer, etc.) or qualitative score (e.g., high, medium, low, etc.). For simplicity, it is shown as a score out of 10.

At 708, LMS 202 executes at least one other machine learning model configured to generate a modified curriculum in which the content is inserted into an original sequence of courses associated with the at least one curriculum based on prerequisites of the content and available resources to provide access to the content.

In some aspects, the at least one other machine learning model comprises a second machine learning model (e.g., sequencer 206) configured to generate a first output sequence based on an input sequence and prerequisites of each content in the input sequence and a third machine learning model (e.g., resource evaluator 208) configured to generate a second output sequence based on the first output sequence and resource requirements and availability of content in the first output sequence. Essentially, the first, second, and third machine learning models may be executed in order such that the output of the first is the input of the second and the output of the second is the input of the third. The third machine learning model generates the modified curriculum which has a structure mirroring the second output sequence.

In some aspects, the at least one other machine learning model generates multiple candidate curricula which comprises the modified curriculum. Accordingly, LMS 202 generates, for display on the UI 106, the multiple candidate curricula (stored in curriculum database 216). LMS 202 may then receive, via the UI 106, a user selection of the modified curriculum.

At 710, LMS 202 generates, for display on the UI, the modified curriculum. For example, LMS 202 may generate modified curriculum 608 on UI 106.

In some aspects, LMS 202 receives, via the UI 106, a user request to further modify the modified curriculum, and in response, executes the user request. For example, the user request may involve changing a duration or difficulty level of the content in the modified curriculum. The user request may involve changing an order of the output sequence associated with the modified curriculum (e.g., removing content, adding content, replacing content, shifting content, reallocating resources, etc.).

In some aspects, LMS 202 monitors an administration of the modified curriculum (e.g., during a school year). The monitoring comprises collecting statistics about access and usage of the content (e.g., a number of classes, attendance, student feedback, test scores, etc.). LMS 202 then executes a fourth machine learning model (e.g., course monitor 210) that recommends a modification to the modified curriculum based on the statistics. For example, course monitor 210 may recommend adding additional classes for a course if the course is highly popular.

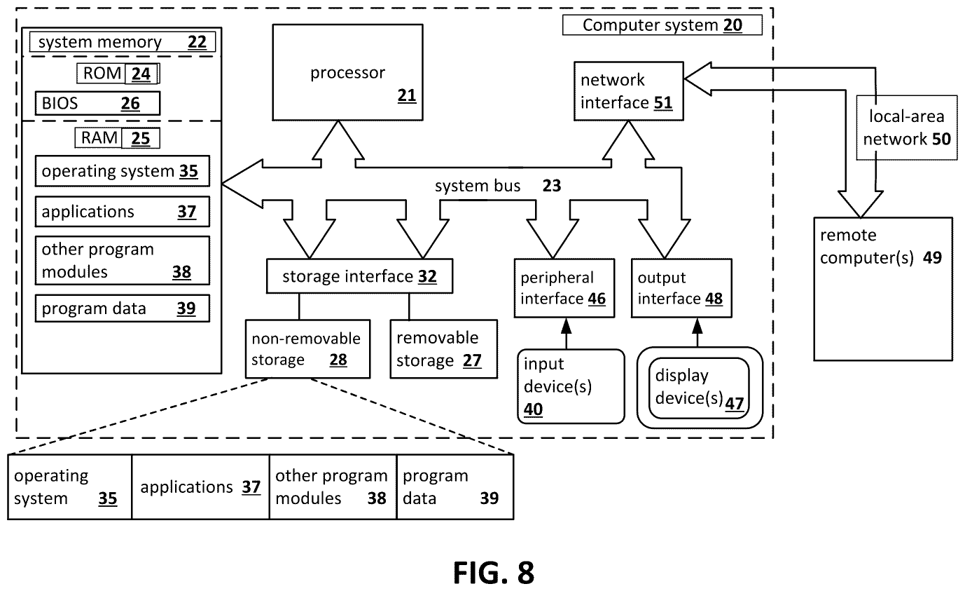

FIG. 8 is a block diagram illustrating a computer system 20 on which aspects of systems and methods for integrating custom courses into a curriculum using machine learning may be implemented in accordance with an exemplary aspect. The computer system 20 can be in the form of multiple computing devices, or in the form of a single computing device, for example, a desktop computer, a notebook computer, a laptop computer, a mobile computing device, a smart phone, a tablet computer, a server, a mainframe, an embedded device, and other forms of computing devices.

As shown, the computer system 20 includes a central processing unit (CPU) 21, a system memory 22, and a system bus 23 connecting the various system components, including the memory associated with the central processing unit 21. The system bus 23 may comprise a bus memory or bus memory controller, a peripheral bus, and a local bus that is able to interact with any other bus architecture. Examples of the buses may include PCI, ISA, PCI-Express, HyperTransport™, InfiniBand™, Serial ATA, I2C, and other suitable interconnects. The central processing unit 21 (also referred to as a processor) can include a single or multiple sets of processors having single or multiple cores. The processor 21 may execute one or more computer-executable code implementing the techniques of the present disclosure. For example, any of commands/steps discussed in FIGS. 1-7 may be performed by processor 21. The system memory 22 may be any memory for storing data used herein and/or computer programs that are executable by the processor 21. The system memory 22 may include volatile memory such as a random access memory (RAM) 25 and non-volatile memory such as a read only memory (ROM) 24, flash memory, etc., or any combination thereof. The basic input/output system (BIOS) 26 may store the basic procedures for transfer of information between elements of the computer system 20, such as those at the time of loading the operating system with the use of the ROM 24.

The computer system 20 may include one or more storage devices such as one or more removable storage devices 27, one or more non-removable storage devices 28, or a combination thereof. The one or more removable storage devices 27 and non-removable storage devices 28 are connected to the system bus 23 via a storage interface 32. In an aspect, the storage devices and the corresponding computer-readable storage media are power-independent modules for the storage of computer instructions, data structures, program modules, and other data of the computer system 20. The system memory 22, removable storage devices 27, and non-removable storage devices 28 may use a variety of computer-readable storage media. Examples of computer-readable storage media include machine memory such as cache, SRAM, DRAM, zero capacitor RAM, twin transistor RAM, eDRAM, EDO RAM, DDR RAM, EEPROM, NRAM, RRAM, SONOS, PRAM; flash memory or other memory technology such as in solid state drives (SSDs) or flash drives; magnetic cassettes, magnetic tape, and magnetic disk storage such as in hard disk drives or floppy disks; optical storage such as in compact disks (CD-ROM) or digital versatile disks (DVDs); and any other medium which may be used to store the desired data and which can be accessed by the computer system 20.

The system memory 22, removable storage devices 27, and non-removable storage devices 28 of the computer system 20 may be used to store an operating system 35, additional program applications 37, other program modules 38, and program data 39. The computer system 20 may include a peripheral interface 46 for communicating data from input devices 40, such as a keyboard, mouse, stylus, game controller, voice input device, touch input device, or other peripheral devices, such as a printer or scanner via one or more I/O ports, such as a serial port, a parallel port, a universal serial bus (USB), or other peripheral interface. A display device 47 such as one or more monitors, projectors, or integrated display, may also be connected to the system bus 23 across an output interface 48, such as a video adapter. In addition to the display devices 47, the computer system 20 may be equipped with other peripheral output devices (not shown), such as loudspeakers and other audiovisual devices.

The computer system 20 may operate in a network environment, using a network connection to one or more remote computers 49. The remote computer (or computers) 49 may be local computer workstations or servers comprising most or all of the aforementioned elements in describing the nature of a computer system 20. Other devices may also be present in the computer network, such as, but not limited to, routers, network stations, peer devices or other network nodes. The computer system 20 may include one or more network interfaces 51 or network adapters for communicating with the remote computers 49 via one or more networks such as a local-area computer network (LAN) 50, a wide-area computer network (WAN), an intranet, and the Internet. Examples of the network interface 51 may include an Ethernet interface, a Frame Relay interface, SONET interface, and wireless interfaces.

Aspects of the present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store program code in the form of instructions or data structures that can be accessed by a processor of a computing device, such as the computing system 20. The computer readable storage medium may be an electronic storage device, a magnetic storage device, an optical storage device, an electromagnetic storage device, a semiconductor storage device, or any suitable combination thereof. By way of example, such computer-readable storage medium can comprise a random access memory (RAM), a read-only memory (ROM), EEPROM, a portable compact disc read-only memory (CD-ROM), a digital versatile disk (DVD), flash memory, a hard disk, a portable computer diskette, a memory stick, a floppy disk, or even a mechanically encoded device such as punch-cards or raised structures in a groove having instructions recorded thereon. As used herein, a computer readable storage medium is not to be construed as being transitory signals per se, such as radio waves or other freely propagating electromagnetic waves, electromagnetic waves propagating through a waveguide or transmission media, or electrical signals transmitted through a wire.

Computer readable program instructions described herein can be downloaded to respective computing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network interface in each computing device receives computer readable program instructions from the network and forwards the computer readable program instructions for storage in a computer readable storage medium within the respective computing device.

Computer readable program instructions for carrying out operations of the present disclosure may be assembly instructions, instruction-set-architecture (ISA) instructions, machine instructions, machine dependent instructions, microcode, firmware instructions, state-setting data, or either source code or object code written in any combination of one or more programming languages, including an object oriented programming language, and conventional procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or WAN, or the connection may be made to an external computer (for example, through the Internet). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

In various aspects, the systems and methods described in the present disclosure can be addressed in terms of modules. The term “module” as used herein refers to a real-world device, component, or arrangement of components implemented using hardware, such as by an application specific integrated circuit (ASIC) or FPGA, for example, or as a combination of hardware and software, such as by a microprocessor system and a set of instructions to implement the module's functionality, which (while being executed) transform the microprocessor system into a special-purpose device. A module may also be implemented as a combination of the two, with certain functions facilitated by hardware alone, and other functions facilitated by a combination of hardware and software. In certain implementations, at least a portion, and in some cases, all, of a module may be executed on the processor of a computer system. Accordingly, each module may be realized in a variety of suitable configurations, and should not be limited to any particular implementation exemplified herein.

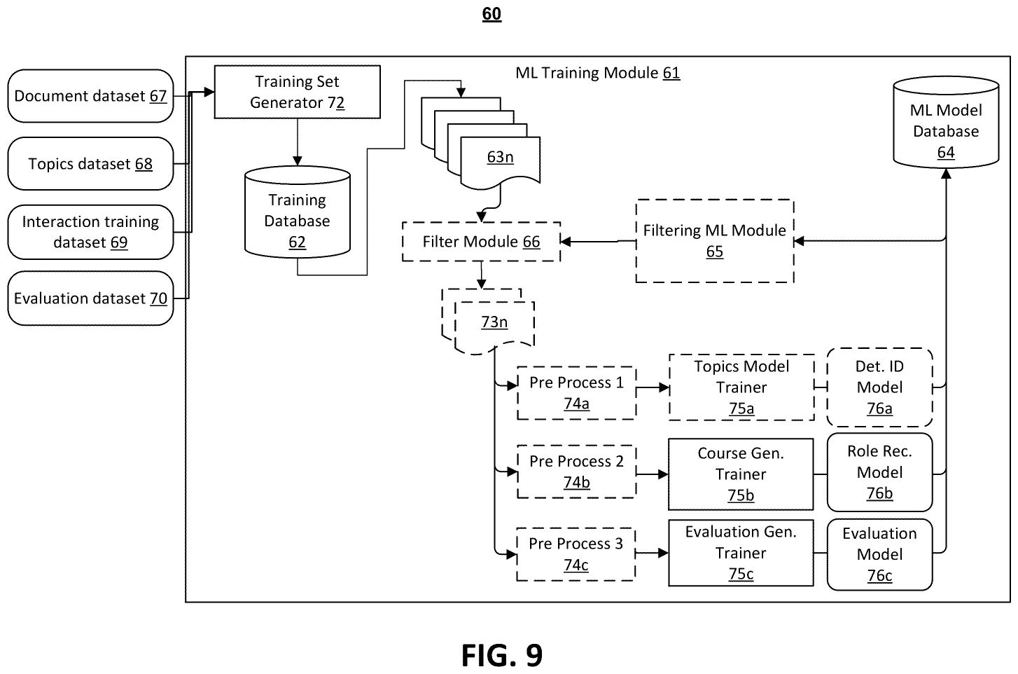

FIG. 9 is a block diagram illustrating a system 60 for training course generator 102 to generate custom courses according to aspects of the present disclosure. As shown in example 60, a ML training module 61 is configured to build and train specialized machine learning models with inference to perform particular tasks. This enables the specialized machine learning models to develop an ability to perform particular objectives on inputs that are not part of a training dataset. By subjecting the specialized machine learning models to large amounts of unlabeled and/or labeled trained image data sets, the specialized machine learning models may perform particular tasks such as course generation.

Supervised learning is effective for tasks such as classification (assigning inputs to predefined categories) and regression (predicting continuous values) since it relies on the availability of labeled data for both training and evaluation phases. In supervised learning, the ML training module 61 trains the algorithm on a labeled dataset, where each input has a corresponding output. The goal is to learn a mapping function from inputs to outputs, allowing the algorithm to make predictions or classifications on new, unseen data. The process typically involves the following steps: training, model building, prediction, feedback, and adjustment. In the training phase, the ML training module 61 provides the algorithm with a training dataset including input-output pairs. The algorithm learns the mapping function that relates inputs to outputs through an iterative process, adjusting its internal parameters based on the provided examples. During model building, the algorithm creates a model that can generalize from the training data to make predictions on new, unseen data. The model's complexity varies based on the algorithm used. For example, the model may be a simple linear regression model or a complex neural network. During the prediction phase, the ML training module 61 inputs test inputs (i.e., inputs with known outputs) into the model, which generates predictions or classifications based on what it has learned during training. The accuracy of predictions is evaluated by comparing them to the known outputs in a validation or test dataset. During the feedback and adjustment phase, machine refines the model based on feedback from its predictions. If the predictions differ from the actual outputs, the algorithm adjusts its internal parameters to minimize the errors. The performance of the trained model is assessed using metrics such as accuracy, precision, recall, etc., depending on the nature of the problem. In some aspects, the ML training module 61 includes at least a training database 62 configured to store the raw training data 63n and corresponding labels, a ML model database 64 to store the trained models (e.g., model 76a, 76b, 76c, etc.). In some aspects, the ML training module 61 may include a filtering machine learning model 65 and a filter module 66 configured to filter data from the training database 62 for training by removing poorly generated training data.

Training data from the document dataset 67, topics dataset 68, interaction training dataset 69, and evaluation dataset 70 is received into the ML training module 61 via the training set generator 72. In some aspects, document dataset 67 includes documents and summarized versions of said documents, topics dataset 68 includes text and identified topics in the text, interaction training dataset 69 includes clickstream user data on the UI, and evaluation dataset 70 including question and answer student performance.

An optional filter module 66 is configured to filter out bad training images and/or data in order to clean up the training data in the training dataset 63n. In some examples, the filter module 66 may be a neural network. In some examples, the filter module 66 is a mathematical model. In some examples, the cleaned training dataset 73n then undergoes optional preprocessing steps depending on which neural network or model is being trained.

The optional preprocess 1 74a, preprocess 2 74b, and preprocess 3 74c are automated processes that modify the raw data received from 63n (or cleaned training dataset 73n) and prepare the raw data as input to the respective model trainers (e.g., a people/object detection model trainer 75a, a role recognition model trainer 75b, and an evaluation model trainer). These may be described in the machine learning training module 61 as snippets of code that prepares the datasets. In some examples, the preprocessing module (e.g., preprocess 1 74a, preprocess 2 74b, and preprocess 3 74c) for a particular trainer may be an automated script or code that will be setup the first time any model is trained.

The topics model trainer 75a, course generation trainer 75a, and evaluation generation trainer 75c are the scripts or code that train the model. The topics model trainer 75a, course generation trainer 75a, and evaluation generation trainer 75c may be a script or code that holds the instructions on how a model should be trained (e.g., optimization method, model architecture, dataset division, etc.) and also runs the training. The topics model trainer 75a, course generation trainer 75a, and evaluation generation trainer 75c each take as input the raw or filtered processed training data and train topics model 76a, course generation model 76b, and evaluation generation model 76c to achieve their specific objectives, respectively.

In summary, the raw dataset 63n or cleaned dataset 73n may optionally go through different preprocessing steps 74a, 74b, and 74c and then a corresponding topics model trainer 75a, course generation trainer 75a, and evaluation generation trainer 75c to generate a trained model 76a, a trained course generation model 76b, and a trained evaluation generation model 76c. In some examples, each of these models may be a neural network.

As a non-limiting example, the machine learning may be a neural network. The neural network models are designed using a set of hyperparameters that define high-level aspects of their architecture and training process. These hyperparameters include, but are not limited to a combination of architecture type, number of layers, memory size, number of attention heads, learning rate, batch size, optimization algorithm, and the like. Based on these hyperparameters, learnable variables called parameters are initialized, which define the mathematical function that the neural network represents.

The raw training dataset 63n used for training may include noise and bad training images from the training database 62. Accordingly, to create a clean and filtered training dataset, the filter module 66 is configured to filter out unwanted data points from the raw training dataset 63n by developing smaller, less accurate systems based on patterns and metadata information.

During the training process, topics model trainer 75a, course generation trainer 75a, and evaluation generation trainer 75c (e.g., neural networks) are presented with input data and labels of actual values, and the optimization objective, which aims to minimize the difference between the actual value and the predicted value, is calculated. The optimization algorithm updates the parameters of topics model trainer 75a, course generation trainer 75a, and evaluation generation trainer 75c to reduce the value of the objective. This process is repeated for several iterations until the parameters do not change anymore. This process is repeated for various combinations of hyperparameters, and the model with the smallest label prediction error is selected as the final model.

When a new model (e.g., a trained topics model 76a, a trained course generation model 76b, and a trained evaluation generation model 76c) is created, and a new process for filtering and automated labeling is established, it is added to the ML model database 64 in the ML training module 61. This enables the new model to be part of the closed-loop model update process. Optionally, at regular intervals, data which is continuously collected can be filtered, labeled, and used to update old models by an optional filtering machine learning module 65. In some examples, the filtering machine learning module 65 is a neural network. In some examples, the filtering machine learning module 65 is a mathematical model. This approach may capture changes in the data over time.

In the interest of clarity, not all of the routine features of the aspects are disclosed herein. It would be appreciated that in the development of any actual implementation of the present disclosure, numerous implementation-specific decisions must be made in order to achieve the developer's specific goals, and these specific goals will vary for different implementations and different developers. It is understood that such a development effort might be complex and time-consuming, but would nevertheless be a routine undertaking of engineering for those of ordinary skill in the art, having the benefit of this disclosure.

Furthermore, it is to be understood that the phraseology or terminology used herein is for the purpose of description and not of restriction, such that the terminology or phraseology of the present specification is to be interpreted by the skilled in the art in light of the teachings and guidance presented herein, in combination with the knowledge of those skilled in the relevant art(s). Moreover, it is not intended for any term in the specification or claims to be ascribed an uncommon or special meaning unless explicitly set forth as such.

The various aspects disclosed herein encompass present and future known equivalents to the known modules referred to herein by way of illustration. Moreover, while aspects and applications have been shown and described, it would be apparent to those skilled in the art having the benefit of this disclosure that many more modifications than mentioned above are possible without departing from the inventive concepts disclosed herein.

1. A method for integrating content into a sequence using machine learning, the method comprising:
receiving, via a user interface (UI), content describing a topic and a plurality of sub-topics associated with the topic;
executing a first machine learning model configured to determine compatibility scores between the content and a plurality of curricula, wherein each curriculum of the plurality of curricula is a sequence of courses and indicates resources utilized for each respective course in the sequence of courses;
identifying at least one curriculum with a compatibility score greater than a threshold compatibility score;
executing at least one other machine learning model configured to generate a modified curriculum in which the content is inserted into an original sequence of courses associated with the at least one curriculum based on prerequisites of the content and available resources to provide access to the content; and
generating, for display on the UI, the modified curriculum.

2. The method of claim 1, further comprising:
in response to determining that the content is not compatible with any of the plurality of curricula due to a difficulty level of the content and a duration to consume the content, automatically modifying the content using a machine learning algorithm to a duration and a difficulty level associated with other content in the plurality of curricula.

3. The method of claim 2, wherein determining that the content is not compatible with any of the plurality of curricula due to the difficulty level is based on one or more of: expert opinion, output by a machine learning model, and monitored student performance.

4. The method of claim 1, wherein the first machine learning model is a classification model trained using a training dataset in which each training vector comprises at least text from training content and text from training curricula and indicates a corresponding compatibility score between both texts.

5. The method of claim 4, wherein both texts comprise one or more objectives, topic descriptions, durations, difficulty levels, and policy information.

6. The method of claim 1, wherein the at least one other machine learning model comprises a second machine learning model configured to generate a first output sequence based on an input sequence and prerequisites of each content in the input sequence and a third machine learning model configured to generate a second output sequence based on the first output sequence and resource requirements and availability of content in the first output sequence.

7. The method of claim 1, wherein the at least one other machine learning model generates multiple candidate curricula which comprises the modified curriculum, further comprising:
generating, for display on the UI, the multiple candidate curricula; and
receiving, via the UI, a user selection of the modified curriculum.

8. The method of claim 1, further comprising:
receiving, via the UI, a user request to further modify the modified curriculum; and
executing the user request.

9. The method of claim 1, further comprising:
monitoring an administration of the modified curriculum, wherein the monitoring comprises collecting statistics about access and usage of the content; and
executing a fourth machine learning model that recommends a modification to the modified curriculum based on the statistics.

10. The method of the claim 1, wherein the compatibility score can be manually changed via the UI.

11. A system for integrating content into a sequence using machine learning, comprising:
at least one memory; and
at least one hardware processor coupled with the at least one memory and configured, individually or in combination, to:
receive, via a user interface (UI), content describing a topic and a plurality of sub-topics associated with the topic;
execute a first machine learning model configured to determine compatibility scores between the content and a plurality of curricula, wherein each curriculum of the plurality of curricula is a sequence of courses and indicates resources utilized for each respective course in the sequence of courses;
identify at least one curriculum with a compatibility score greater than a threshold compatibility score;
execute at least one other machine learning model configured to generate a modified curriculum in which the content is inserted into an original sequence of courses associated with the at least one curriculum based on prerequisites of the content and available resources to provide access to the content; and
generate, for display on the UI, the modified curriculum.

12. The system of claim 11, wherein the at least one hardware processor is further configured to:
in response to determining that the content is not compatible with any of the plurality of curricula due to a difficulty level of the content and a duration to consume the content, automatically modify the content using a machine learning algorithm to a duration and a difficulty level associated with other content in the plurality of curricula.

13. The system of claim 11, wherein the first machine learning model is a classification model trained using a training dataset in which each training vector comprises at least text from training content and text from training curricula and indicates a corresponding compatibility score between both texts.

14. The system of claim 13, wherein both texts comprise one or more objectives, topic descriptions, durations, difficulty levels, and policy information.

15. The system of claim 11, wherein the at least one other machine learning model comprises a second machine learning model configured to generate a first output sequence based on an input sequence and prerequisites of each content in the input sequence and a third machine learning model configured to generate a second output sequence based on the first output sequence and resource requirements and availability of content in the first output sequence.

16. The system of claim 11, wherein the at least one other machine learning model generates multiple candidate curricula which comprises the modified curriculum, wherein the at least one hardware processor is further configured to:
generate, for display on the UI, the multiple candidate curricula; and
receive, via the UI, a user selection of the modified curriculum.

17. The system of claim 11, wherein the at least one hardware processor is further configured to:
receive, via the UI, a user request to further modify the modified curriculum; and
execute the user request.

18. The system of claim 11, wherein the at least one hardware processor is further configured to:
monitor an administration of the modified curriculum, wherein the monitoring comprises collecting statistics about access and usage of the content; and
execute a fourth machine learning model that recommends a modification to the modified curriculum based on the statistics.

19. A non-transitory computer readable medium storing thereon computer executable instructions for integrating content into a sequence using machine learning, including instructions for:
receiving, via a user interface (UI), content describing a topic and a plurality of sub-topics associated with the topic;
executing a first machine learning model configured to determine compatibility scores between the content and a plurality of curricula, wherein each curriculum of the plurality of curricula is a sequence of courses and indicates resources utilized for each respective course in the sequence of courses;
identifying at least one curriculum with a compatibility score greater than a threshold compatibility score;
executing at least one other machine learning model configured to generate a modified curriculum in which the content is inserted into an original sequence of courses associated with the at least one curriculum based on prerequisites of the content and available resources to provide access to the content; and
generating, for display on the UI, the modified curriculum.
